(19) United States
(12) Patent Application Publication
(10) Pub. No.: US 2023/0329390 A1
(43) Pub. Date: Oct. 19, 2023

(54) CYCLING SHOES AND CYCLING SHOE SYSTEMS

(71) Applicant: SVVETTE, LLC, Glendale, CA (US)

(72) Inventors: Caleb DEWART, Glendale, CA (US); Thomas M. BEREND, Portland, OR (US); Gregory R. LEEDY, Portland, OR (US); Kristina Leah Sheedy KURCINKA, Portland, OR (US); Jacob C. LEWIS, Portland, OR (US)

(21) Appl. No.: 18/135,785

(22) Filed: Apr. 18, 2023

Related U.S. Application Data
(60) Provisional application No. 63/332,429, filed on Apr. 19, 2022.

(51) Int. Cl. A43B 5/14; A43B 1/14; A43B 1/04

(52) U.S. Cl. CPC A43B 5/14; A43B 1/14; A43B 1/04

(57) ABSTRACT

The present disclosure is directed to cycling shoes, and in particular to indoor cycling shoes, having an outer shoe body configured to receive an inner, removable upper. Advantageously, in some implementations the outer shoe body does not include shoe components that become wet during use and are slow to dry, such as fabric (synthetic leather, real leather, Nylon mesh, etc.), padding, or an insole The functionality of these components is instead provided by the removable and easy to dry upper.

### RELATED APPLICATIONS

The present application claims priority from U.S. Provisional Patent Application Ser. No. 63/332,429 filed on Apr. 19, 2022, and herein incorporated by reference in its entirety.

### BACKGROUND

Many types of shoes are available for bicycling, both outdoors and indoors. Indoor cycling may be performed on a stationary bike (also referred to as an exercise bike) or on a conventional bike mounted on a bike trainer or positioned on rollers.

One problem with cycling shoes, and in particular shoes used for indoor cycling, is that they may get saturated with sweat or when cycling outdoors, with mud, rainwater, or water from stream crossings—and may be difficult to dry between uses. Build-up of sweat and/or wet shoes being dried improperly (for example thrown into a gym bag or suitcase for travel while wet) may also lead to cycling shoes developing a strong, unpleasant odor. Bad smelling shoes may be a challenge to store, transport, and wear in public, particularly for indoor cycling.

In an effort to address these problems, bicyclists resort to measures such as stuffing shoes with newspaper, leaving them outside in the elements, drying them with a ski boot dryer, and having multiple pairs of shoes to wear on alternate days. Cycling shoe companies have increased the ventilation of shoe uppers, which may help reduce the sweating of the user's feet but does not address other sources of moisture such as sweat running down from other parts of the user's body or sources of moisture found outdoors.

### SUMMARY

The present disclosure is directed to cycling shoes, and in particular to indoor cycling shoes, having an outer shoe body configured to receive an inner, removable upper. Advantageously, in some implementations the outer shoe body does not include shoe components that become wet during use and are slow to dry, such as fabric (synthetic leather, genuine leather, Nylon mesh, etc.), padding, or an insole. The functionality of these components is instead provided by the removable and easy to dry upper.

In one aspect, the disclosure features a cycling shoe system comprising (a) a shoe body comprising a rigid plate and a flexible chassis mounted on the plate, the chassis including a plurality of through holes configured to allow air flow through the chassis, and (b) an upper configured to be removably inserted into the shoe body and to be in direct contact with an inner surface of the chassis when inserted, the upper having a predetermined three-dimensional shape when removed from the shoe body.

Some implementations include one or more of the following features. The chassis may comprise a foam material. The chassis may be formed of a closed cell ethylene-vinyl acetate (EVA) foam. The chassis may be configured to contact the sole, sides, heel, and toes of a user, but not the upper forefoot of the user. The system may further include a strap configured to retain a user's foot in the chassis, which may be removable from the shoe body. The plate may include openings adjacent side surfaces of the chassis and the strap is threaded through the openings. The plate may be formed of a composite comprising a thermoplastic and carbon fibers or glass fibers. The upper may be knitted and thermoformed on a last and may comprise elastic yarns. In some cases, the upper includes thermoplastic urethane (TPU) yarns and may also include polyester yarns. Portions of the chassis may extend through through-holes in the plate to provide lugs to facilitate walking.

In another aspect, the disclosure features a cycling shoe that includes a shoe body comprising a rigid plate, and a flexible chassis mounted on the plate. The chassis includes a plurality of through holes configured to allow air flow through the chassis, and is configured to contact the sole, sides, heel, and toes of a user, but not contact the upper forefoot of the user.

Some implementations include one or more of the features discussed above.

In yet a further aspect, the disclosure features a method of manufacturing a cycling shoe, the method comprising: (a) forming a shoe body comprising a rigid plate and a flexible chassis mounted on the plate, the chassis including a plurality of through holes configured to allow air flow through the chassis, and (b) forming an upper configured to be removably inserted into the shoe body and to be in direct contact with an inner surface of the chassis when inserted, the upper having a predetermined three-dimensional shape when removed from the shoe body.

Some implementations include one or more of the following features. The chassis may be formed on a first last, and the upper is formed on a second last, smaller than the first last. The method may further include stock fitting and cementing the chassis to the plate. The method may further include heat treating the upper with steam while on the upper is on the second last. The method may also include chilling the upper after heat treating. Forming the upper may include flat knitting a flat upper blank and seaming the blank, for example on a sole area of the upper, to form the three-dimensional shape. Flat knitting may also provide the upper with zonal support in heel and forefoot areas and cushioning across the top of the foot.

In another aspect, the disclosure features an upper for a cycling shoe system, the upper comprising a knit body having a predetermined three-dimensional shape, the knit body comprising a flat knitted blank that includes TPU formable yarns and is seamed to provide shape to the body.

Some implementations include one or more of the following features. The blank may further include polyester threads. The three-dimensional shape may be selected to resemble the shape of a foot and ankle. The knit body may include areas of zonal support and/or cushioned areas.

Within this specification embodiments have been described in a way which enables a clear and concise specification to be written, but it is intended and will be appreciated that embodiments may be variously combined or separated without parting from the invention. For example, it will be appreciated that all preferred features described herein are applicable to all aspects of the invention described herein.

### DESCRIPTION OF THE DRAWINGS

FIG. 1 is a side view of a cycling shoe system according to one implementation.

FIG. 1A is an exploded side view of the components of the cycling shoe system shown in FIG. 1.

FIG. 2 is a perspective view of the assembled chassis component of the shoe system.

FIG. 3 is a side view of the chassis on the lateral side of the foot.

FIG. 4 is a side view of the chassis on the opposite, medial side of the foot.

FIG. 5 is a top view of the chassis.

FIG. 6 is a bottom view of the chassis.

FIG. 7 is a front view of the chassis.

FIG. 8 is a rear view of the chassis.

FIG. 9 is a diagrammatic top view of the chassis showing where the cross-sections in FIGS. 9A-9E are taken.

FIG. 9A is a cross-sectional view taken along line A-A in FIG. 9.

FIG. 9B is a cross-sectional view taken along line B-B in FIG. 9.

FIG. 9C is a cross-sectional view taken along line C-C in FIG. 9.

FIG. 9D is a cross-sectional view taken along line D-D in FIG. 9.

FIG. 9E is a cross-sectional view taken along line E-E in FIG. 9.

FIG. 10 is top view of an upper according to one implementation.

FIG. 11 is a side view of the upper of FIG. 10.

FIG. 12 is a bottom view of the upper of FIG. 10.

### DETAILED DESCRIPTION

The cycling shoe systems described herein, and their components, are designed to provide a stable outer shoe body with a rigid sole for reliable performance while cycling, while also allowing the user to remove the upper of the shoe system for drying and in some implementations for washing and/or replacement when worn.

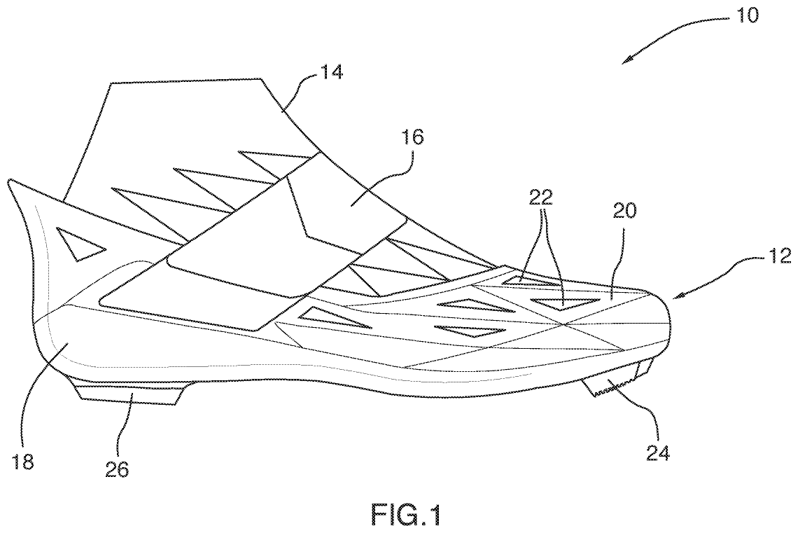

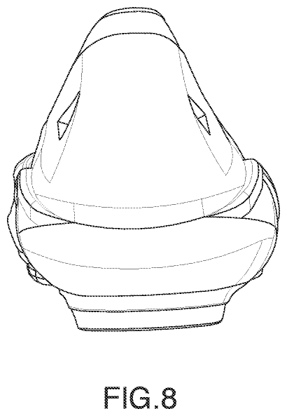

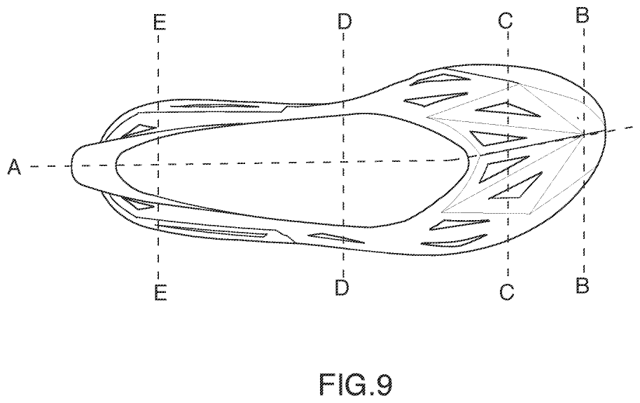

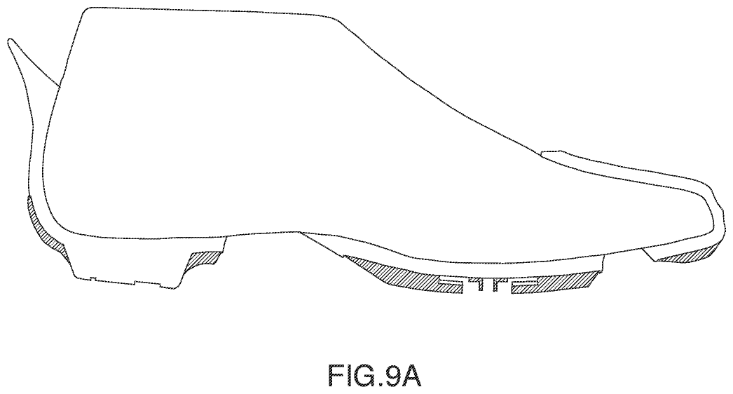

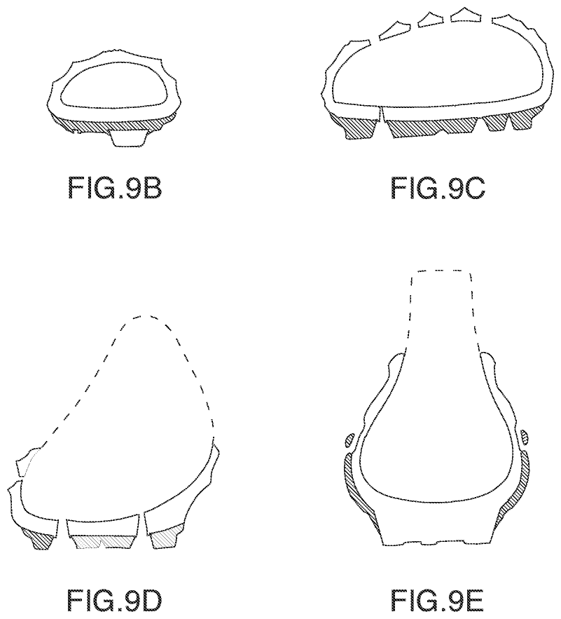

Referring to FIGS. 1 and 1A, cycling shoe system 10 includes a shoe body 12, a removable upper 14, and a strap 16. The shoe body 12 includes a rigid plate 18 and, mounted permanently on the plate, a foam chassis 20. The chassis 20 may be mounted on the plate 18 by, for example, cementing the chassis to the plate with an adhesive. In some implementations the chassis and plate are molded separately, stock fitted together and cemented to form the shoe body, and then the assembled shoe body is formed on a last (shown in dotted lines in FIGS. 9D and 9E).

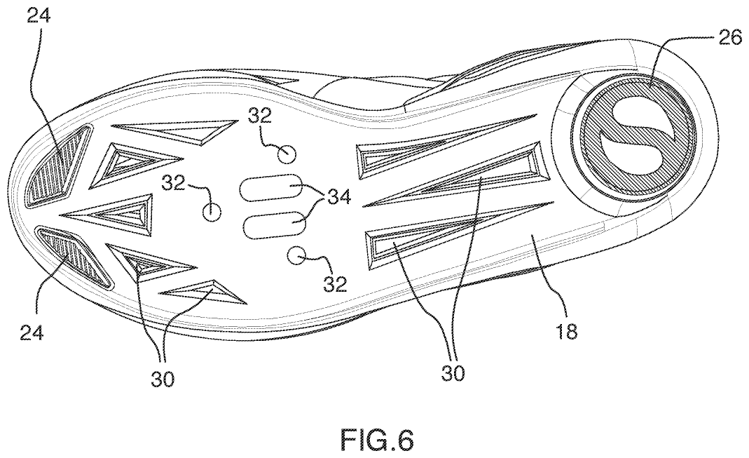

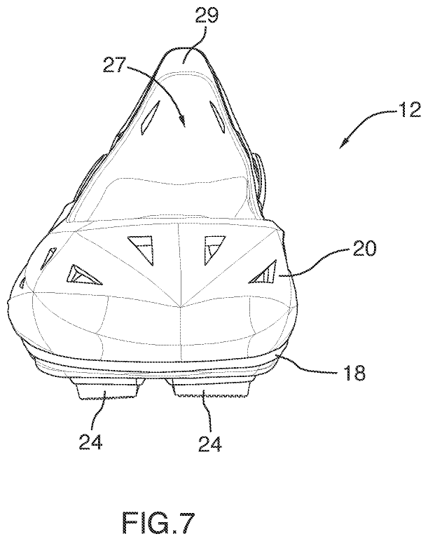

In most implementations, the plate 18 is rigid, to provide support while cycling, as is well known in the cycling shoe art. The plate 18 may be formed, for example, from a composite of Nylon® and glass or carbon fiber and may be injection molded. Referring to FIG. 6, the plate 18 includes a plurality of cutouts 30 to provide ventilation, assist with airflow for drying, and reduce the overall weight of the shoe system. The sole also includes apertures 32 and slots 34, provided in the standard pattern for attachment of conventional cycling cleats (not shown) for clipless pedals.

The chassis 20 is formed of a resilient material, e.g., a foam material, for example a closed cell injected EVA foam. The foam may have a hardness, for example, of from about 50 to 70 Asker C, and in some cases from about 60 to 65 Asker C. The foam is preferably sufficiently hard to provide support for the user's foot, while being sufficiently soft to allow the chassis to conform to and hug the user's foot.

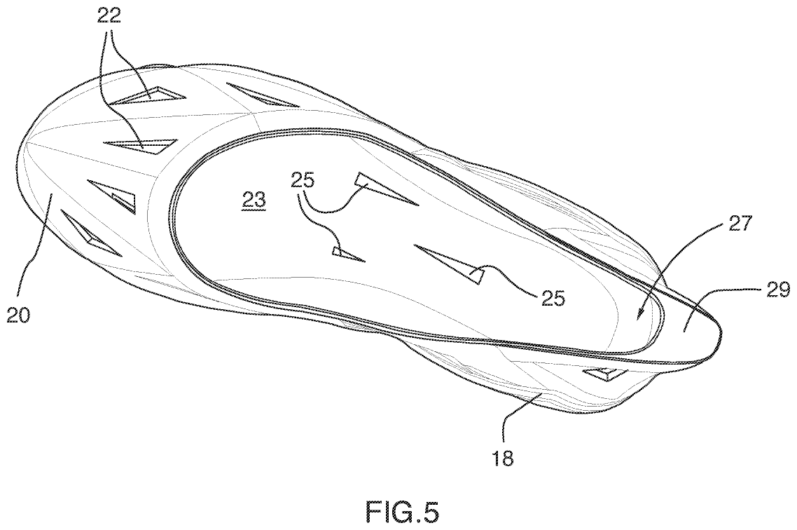

The chassis 20 includes a number of cutouts 22 for cooling, breathability, and to allow water vapor from sweat to vent out of the shoe. The cutouts also provide airflow through the shoe body when the user removes the upper 14, allowing the inside of the shoe body to dry quickly between uses. Preferably the sole portion 23 of the chassis (FIG. 5) also includes cutouts 25 that align with the cutouts 30 in the plate, to provide ventilation, airflow, and drainage of sweat from the shoe body during cycling. The sole portion 23 also provides the sole cushioning and arch support functionality that is conventionally provided by an insole, eliminating the need for an insole which would tend to absorb sweat or other liquid and require drying.

Unlike the upper of a conventional cycling shoe, the chassis 20 does not include any lining or padding material, and cutouts 22 are through-holes, rather than vents covered with material. As a result, the chassis 20 does not tend to absorb sweat or water, and to the extent that it becomes damp during use it may easily and quickly dry after the sock component is removed. Moreover, in the implementation shown in the figures, the chassis 20 does not cover a major portion of the upper surface of a user's foot, as is the case with conventional cycling shoes, but instead only covers the toes (phalange bones) of the user, leaving the rest of the upper surface of the user's foot exposed. As a result, there is a large open area in the chassis for ventilation and airflow both during use and when the upper is removed between uses.

The chassis 20 includes toe elements 24 and heel element 26 (FIGS. 1A and 6) which extend through corresponding openings (not shown) in the plate 18 to provide lugs for better grip on a walking surface, in particular a smooth surface such as the floor of a gym or fitness center.

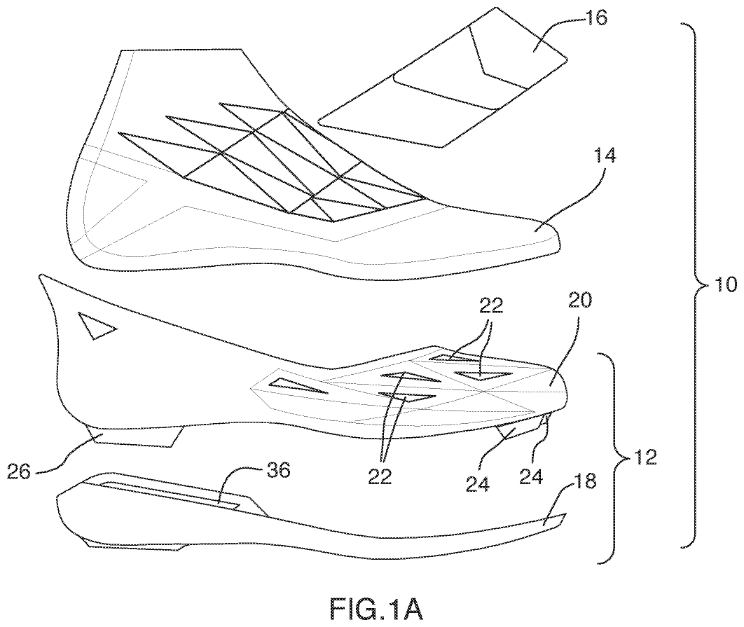

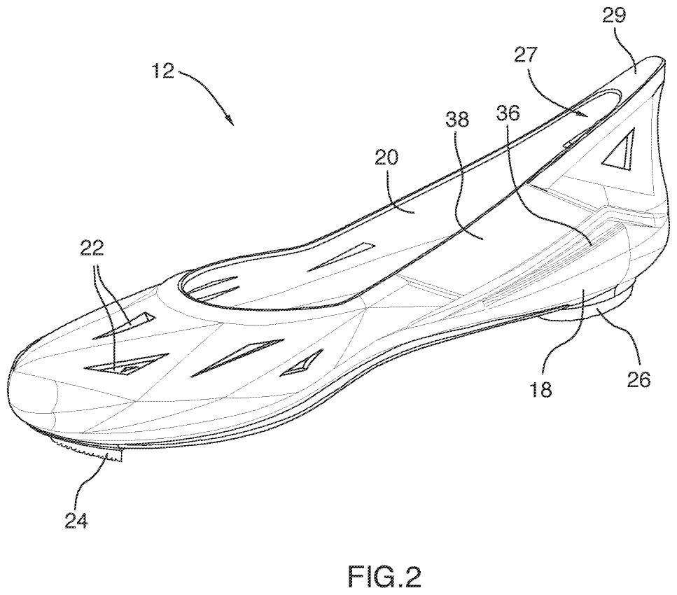

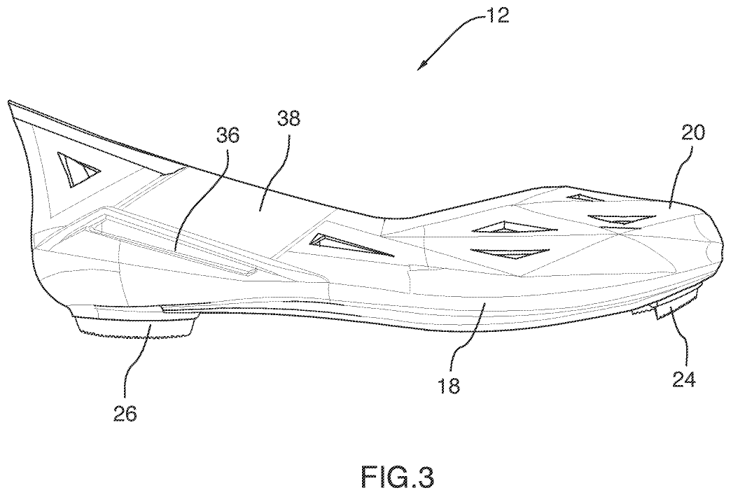

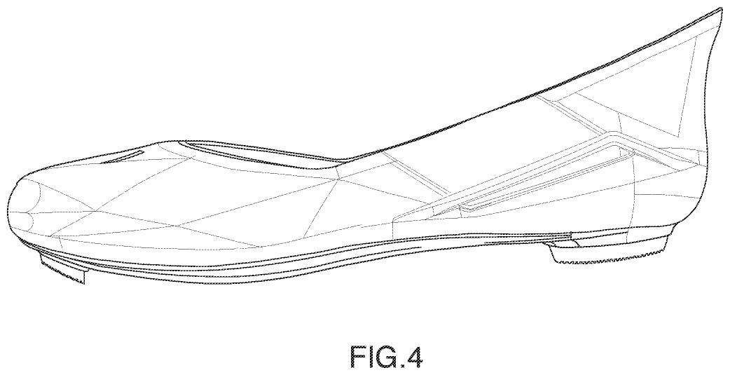

The chassis 20 also includes a heel cup 27 (FIGS. 2 and 5) that supports and cradles the user's heel and the back of the user's ankle (Achilles' tendon area). Heel cup 27 is shaped to surround the user's heel and to prevent the user's foot from lifting out of or moving within the chassis, for example when the user stands to pedal. Horn 29 extends behind the user's ankle and facilitates the removal of the shoe body by the user. As shown in FIG. 5, an inner surface of the horn 29 is curved, easing insertion of the user's foot (wearing the upper) into the chassis. The horn 29 may also be used to assist with insertion of the upper into the chassis, e.g., after washing and drying, for storage of the shoe system 10 as a unit.

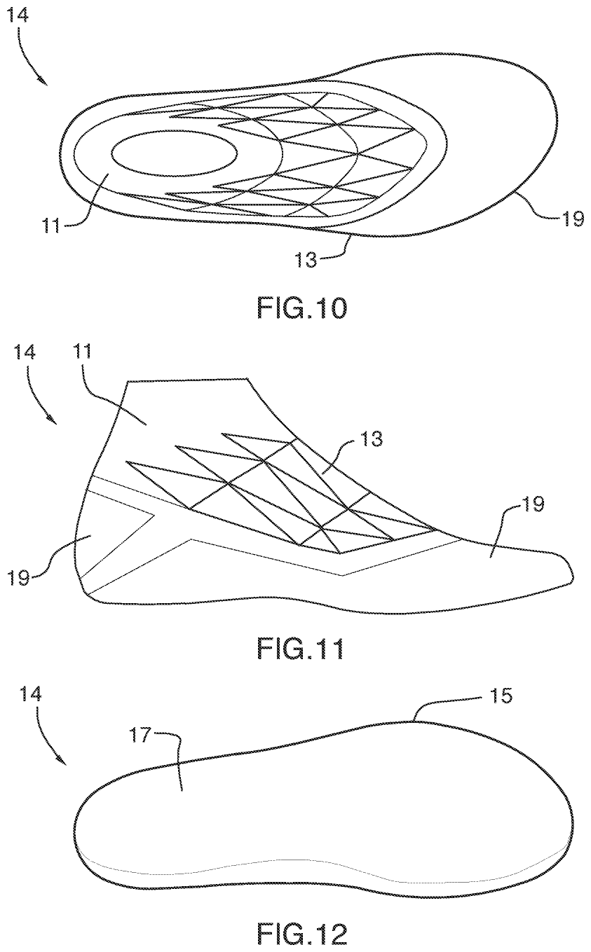

Removable upper 14, shown in detail in FIGS. 10-12, is configured in the implementation shown to have sufficient structural integrity so that it stands up on its own as a three dimensional foot-shaped object, in the position shown in the drawings, rather than lying flat on a surface like an ordinary textile sock. To achieve this, the upper is formed of polyester and thermoplastic elastomer (TPU) threads that are garment knit in the same manner conventionally used to form a knitted shoe upper. The yarns are flat knit, positioned on a last (a separate last that is slightly smaller than the last used to form the chassis), and then seamed (e.g., along the sole surface—see seam 15 on sole 17 in FIG. 12) to form the desired upper shape. The upper is steamed while on the last so that the yarns may take on the desired shape and then chilled prior to removal from the last.

The upper includes an ankle opening area 11 having greater stretch, to allow easy insertion of a foot and a snug fit of the upper against the user's ankle. The upper is designed to provide cushioning, in particular in strap area 13, where the upper provides protection between the user's foot and the strap 16 to allow the strap to be firmly tightened and the user's foot to pull up against the strap during pedaling without irritation to the foot. Zonal support is provided in the heel and forefoot areas, by providing areas 19 of power-stretch material. The selection of the TPU yarns and proportion of TPU yarns to polyester yarns is generally used to provide zonal support, while knitting techniques are used to provide areas of cushioning. It should be noted that the upper may be provided as a replacement part independent of the system. For example, should the upper cushioning wear and therefore reduce the snug fit against the user's ankle, a replacement upper may be provided in accordance with the present invention.

In some implementations the upper is configured so that it may be worn independently of the shoe body, e.g., as a slipper or bootie when walking around a locker room or gym, or even into a shower area. For example, the sole of the upper may include traction areas (not shown) to provide better traction during walking.

The upper is also configured to fit snugly within the shoe body, to prevent undesirable movement of the foot during cycling. It is generally preferred that the chassis slightly compress the upper when the user inserts the foot and upper into the chassis, insuring a close fit.

The strap 16 is formed of a webbing material and includes hook and loop fasteners (not shown). Strap 16 is threaded through openings 36 on the plate 18 (FIG. 1) and extends across seating grooves 38 on the upper 20 (FIG. 2). Having the strap thread through the rigid plate 18 allows the strap to be securely tightened by the user because the user has the rigid material to pull up against (rather than the softer, flexible material of the chassis). Seating grooves 38 help correctly position the strap on the shoe body and allow it to be easily and securely tightened by a user in the correct position on the user's foot. The strap is located so that when secured it pushes the user's foot down and back, seating the user's heel in the heel cup 27. This allows the user to pull up while pedaling without the foot moving within the chassis, imparting more power to the user's pedal stroke. The positioning of the strap also serves to keep the user's toes securely in the chassis during cycling, despite the very large open area of the chassis discussed above.

In preferred implementations, the strap is removable, allowing it to be replaced as necessary, dried, or interchanged with straps of different colors or characteristics. The strap may include a central area having hook fasteners and two ends having loop fasteners, such that the ends are folded towards the center to engage the loop fasteners with the hook fasteners when the two ends are threaded through the openings 36 in the plate. Other configurations may also be used, for example a tri-fold configuration in which one end of the strap is sandwiched between the other end and the central portion of the strap when the strap is fastened.

FIG. 9 illustrates where the cross-sections are taken for the views in FIGS. 9A-9E. FIGS. 9A-9E, in which dotted lines indicate the last used to form the chassis, show the dimensions of the chassis and plate in various areas of the shoe body. The dimensions are selected so that the chassis and plate are as thin as possible while still providing the desired functionality. In particular, it is preferable that the wall thickness of the crank-facing side of the chassis be sufficiently thin so that the shoe does not contact the crank during the pedal stroke.

In use, a user puts on the upper and inserts his or her foot, wearing the upper, into the shoe body. The user then fastens the strap and is ready to cycle. At the end of a cycling session the user undoes the strap and removes the foot and upper from the shoe body. The upper may then be washed and dried in a conventional manner, and the shoe body wiped out or simply left to dry. As noted above, if desired the user may continue wearing the upper while walking around the workout area and locker room, to protect the user's feet, e.g., from unsanitary floor conditions in a shared space. Drying of the shoe body will occur very quickly, for example in some cases in less than an hour.

### OTHER EMBODIMENTS

A number of embodiments have been described. Nevertheless, it will be understood that various modifications may be made without departing from the spirit and scope of the disclosure.

For example, any or all components of the cycling shoe system may be modified to suit particular cycling conditions or uses, such as mountain biking, outdoor bike racing, or road bicycle touring. For such uses the shape of the shoe body, the materials used in the upper and/or the height of the upper, and/or the size and number of strap(s), may be modified for enhanced performance under a particular set of conditions. As an example, if the shoes are intended for mountain biking additional lugs extending from the chassis through the plate may be provided to enhance the ability to dismount from the bicycle and walk through technical terrain and the upper may extend further up the user's ankle to protect the user's skin.

Moreover, while the upper has been described above as a part of the shoe system, if desired the shoe body and strap may be used with a user's sock. This is generally not desired because the functionality provided by the upper is lacking in conventional socks, however the shoe body will still provide excellent drying characteristics and support the user's foot well during cycling.

Additionally, while the system described above does not include an insole, if desired an insole (removable or permanently affixed) may be included. Similarly, while the system described above does not include padding, so as to avoid the use of components that become saturated and impede drying, padding may be included if desired or if necessary for a particular application.

Accordingly, other embodiments are within the scope of the following claims.

What is claimed:

1. A cycling shoe system comprising:
a shoe body comprising a rigid plate and a flexible chassis mounted on the plate, the chassis including a plurality of through holes configured to allow air flow through the chassis, and
an upper configured to be removably inserted into the shoe body and to be in direct contact with an inner surface of the chassis when inserted, the upper having a predetermined three-dimensional shape when removed from the shoe body.

2. The cycling shoe system of claim 1, wherein the chassis comprises a foam material.

3. The cycling shoe system of claim 1, further comprising a strap configured to retain a user's foot in the chassis.

4. The cycling shoe system of claim 3, wherein the plate includes openings adjacent side surfaces of the chassis, and the strap is threaded through the openings.

5. The cycling shoe system of claim 1, wherein the plate is formed of a composite comprising a thermoplastic and carbon fibers or glass fibers.

6. The cycling shoe system of claim 1, wherein the upper is knitted and thermoformed on a last.

7. The cycling shoe system of claim 1, wherein the upper comprises TPU yarns.

8. The cycling shoe system of claim 7, wherein the upper further comprises polyester yarns.

9. The cycling shoe system of claim 1, wherein portions of the chassis extend through through-holes in the plate to provide lugs to facilitate walking.

10. An upper for a cycling shoe system, the upper comprising:
a knit body having a predetermined three-dimensional shape, the knit body comprising a flat knitted blank that includes TPU formable yarns and is seamed to provide shape to the body.

11. The upper of claim 10 wherein the knit body includes areas of zonal support.

12. The upper of claim 10 wherein the knit body includes cushioned areas.

13. A cycling shoe comprising:
a shoe body comprising a rigid plate and a flexible chassis mounted on the plate, the chassis including a plurality of through holes configured to allow air flow through the chassis and being configured to contact the sole, sides, heel, and toes of a user, but not contact the upper forefoot of the user.

14. The cycling shoe of claim 13, wherein the chassis comprises a foam material.

15. The cycling shoe of claim 14, wherein the chassis is formed of a closed cell EVA foam.

16. The cycling shoe of claim 1, further comprising a strap configured to retain a user's foot in the chassis.

17. The cycling shoe of claim 16, wherein the strap is removable.

18. The cycling shoe system of claim 17, wherein the plate includes openings adjacent side surfaces of the chassis, and the strap is threaded through the openings.

19. The cycling shoe of claim 13, wherein the plate is formed of a composite comprising a thermoplastic and carbon fibers or glass fibers.

20. The cycling shoe system of claim 13, wherein portions of the chassis extend through through-holes in the plate to provide lugs to facilitate walking.
